(19) United States
(12) Patent Application Publication
(10) Pub. No.: US 2026/0095030 A1
(43) Pub. Date: Apr. 2, 2026

(54) RACK ENERGY STORAGE APPARATUS, AND ENERGY STORAGE MODULE

(71) Applicant: Musashi Energy Solutions Co., Ltd., Hokuto-shi (JP)

(72) Inventors: Toshiaki IZAWA, Hokuto-shi (JP); Keita YAMABE, Hokuto-shi (JP); Jeffrey WANG, Gardena, CA (US); Russell OKAMURA, Gardena, CA (US); Grant DUNAWAY, Gardena, CA (US)

(73) Assignee: Musashi Energy Solutions Co., Ltd., Hokuto-shi (JP)

(21) Appl. No.: 18/904,057

(22) Filed: Oct. 1, 2024

(51) Int. Cl. H02B 1/20; H02B 1/26

(52) U.S. Cl. CPC H02B 1/20; H02B 1/26

(57) ABSTRACT

MEANS FOR SOLVING THE PROBLEMS

A rack energy storage apparatus includes a rack, energy storage modules, and first busbars. Each energy storage module includes energy storage cells, a first terminal connector, and a second terminal connector. The first terminal connector extends in a stacking direction of the energy storage modules and is open at ends of the first terminal connector in the stacking direction. The second terminal connector extends in a perpendicular direction and is open at an end in the perpendicular direction. The perpendicular direction is perpendicular to the stacking direction. Each first busbar includes a first end portion and a second end portion. The first end portion extends in the stacking direction and is coupled to the first terminal connector. The second end portion extends in the perpendicular direction and is coupled to the second terminal connector.

### TECHNICAL FIELD

The present disclosure relates to an energy storage apparatus used as a power source.

### BACKGROUND ART

An energy storage apparatus disclosed in Patent Document 1 includes stacked energy storage modules and a busbar coupling a terminal of an upper-positioned energy storage module to a terminal of a lower-positioned energy storage module. However, in the energy storage apparatus of Patent Document 1, the busbar may incorrectly couple terminals that should not be coupled to each other, resulting in a short circuit between the terminals.

In order to inhibit an incorrect connection of the busbar, an energy storage apparatus disclosed in Patent Document 2 includes a safety component that inhibits an incorrect connection of the busbar, in addition to the stacked energy storage modules and the busbar coupling the terminal of the upper-positioned energy storage module to the terminal of the lower-positioned energy storage module.

### PRIOR ART DOCUMENTS

### Patent Documents

[Patent Document 1] U.S. Pat. No. 10,529,965 Specification
[Patent Document 2] U.S. Pat. No. 10,396,340 Specification

### SUMMARY OF THE INVENTION

### Problems to be Solved by the Invention

In the energy storage apparatus of Patent Document 2 described above, there are issues that the safety component has a complicated structure and the cost increases due to the addition of the safety component. Also, there is an issue that the incorrect connection of the busbar cannot be inhibited when the safety component is damaged.

It is desirable that the present disclosure provides a rack energy storage apparatus that can inhibit an incorrect connection with a relatively simple configuration.

### Means for Solving the Problems

In one aspect of the present disclosure, a rack energy storage apparatus comprises a rack, energy storage modules, and first busbars. The energy storage modules are configured to be stored in the rack in a stacked manner. The first busbars are configured to couple the energy storage modules in series with each other. Each energy storage module includes energy storage cells, a first terminal connector, and a second terminal connector. The first terminal connector is arranged on a specific face of the energy storage module. The first terminal connector extends in a stacking direction of the energy storage modules and is open at ends of the first terminal connector in the stacking direction. The second terminal connector is arranged on the specific face. The second terminal connector extends in a perpendicular direction and is open at an end of the second terminal connector in the perpendicular direction. The perpendicular direction is perpendicular to the stacking direction. Each first busbar includes a first end portion and a second end portion. The first end portion extends in the stacking direction and is configured to be coupled to the first terminal connector. The second end portion extends in the perpendicular direction and is configured to be coupled to the second terminal connector.

In the above-described rack energy storage apparatus, an orientation of an opening of the first terminal connector of the energy storage module is perpendicular to an orientation of an opening of the second terminal connector. Accordingly, it is possible to avoid coupling the first busbar to two first terminal connectors of the same polarity and causing a short circuit. In addition, it is possible to avoid coupling the first busbar to two second terminal connectors of the same polarity and causing a short circuit. Accordingly, it is possible to inhibit the incorrect connection of the busbar with a relatively simple configuration.

In another aspect of the present disclosure, an energy storage module is accommodated in a rack and comprises a module case, cell packs, a busbar, and a circuit board. The cell packs are accommodated in an aligned manner in the module case, and include a first cell pack and a second cell pack. The cell packs each include energy storage cells aligned. The second cell pack is arranged in a manner 180° reversed with respect to the first cell pack so as to face the first cell pack. The busbar couples the energy storage cells in parallel and couples adjacent cell packs of the cell packs in series with each other. The circuit board is configured to detect a temperature and a voltage of each of the cell packs.

The above-described energy storage module comprises the circuit board configured to detect a voltage value and a temperature of each of the cell packs, thus enabling management of the voltage and the temperature for each cell pack.

### BRIEF DESCRIPTION OF THE DRAWINGS

FIG. 1 is a front view of a rack energy storage apparatus according to the present embodiment.

FIG. 2 is a perspective view of the rack energy storage apparatus according to the present embodiment.

FIG. 3 is an external view of an energy storage module according to the present embodiment.

FIG. 4 is a diagram showing a busbar, a first terminal connector, and a second terminal connector, according to the present embodiment.

FIG. 5 is a diagram showing the busbar, as well as a bolt and a washer fixing the busbar, according to the present embodiment.

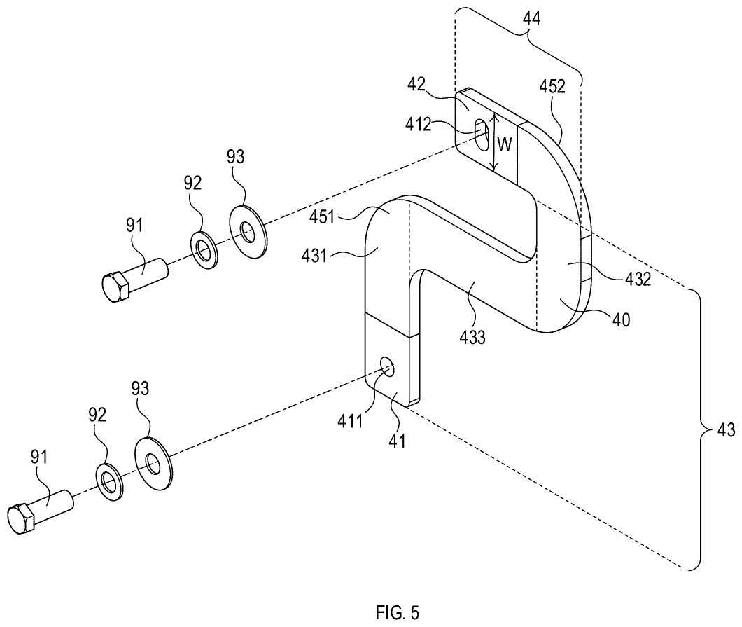

FIG. 6 is a diagram showing an internal structure of the energy storage module according to the present embodiment.

FIG. 7 is a diagram showing an external appearance of a lithium-ion capacitor cell that is an energy storage cell according to the present embodiment.

### MODE FOR CARRYING OUT THE INVENTION

### Embodiment

### 1. Configuration of Rack Energy Storage Apparatus

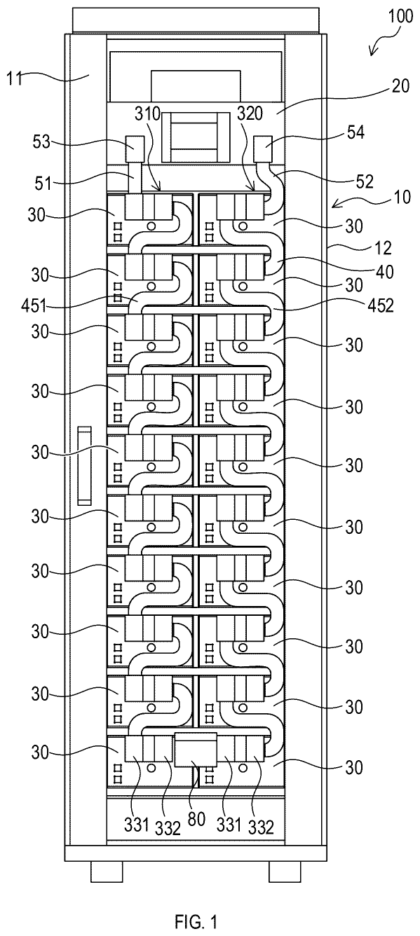

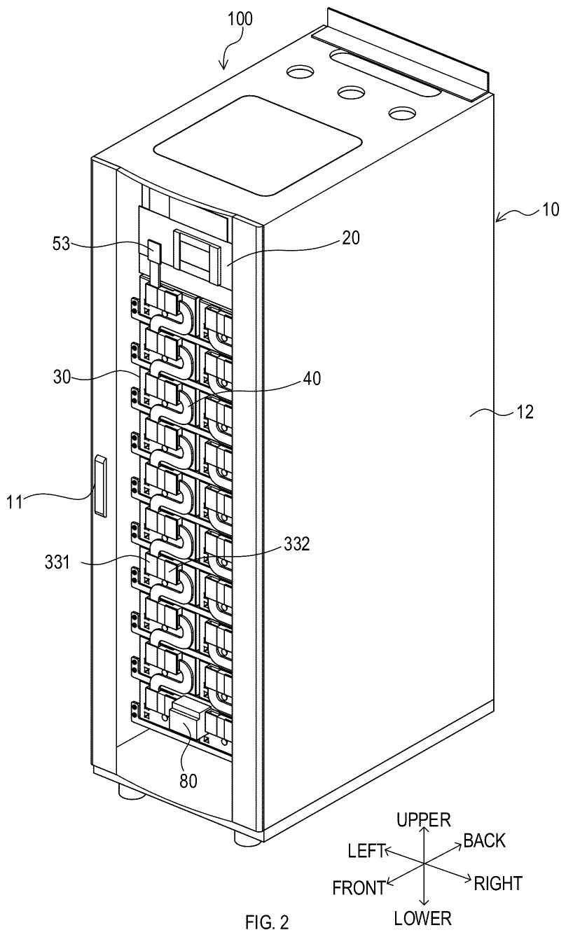

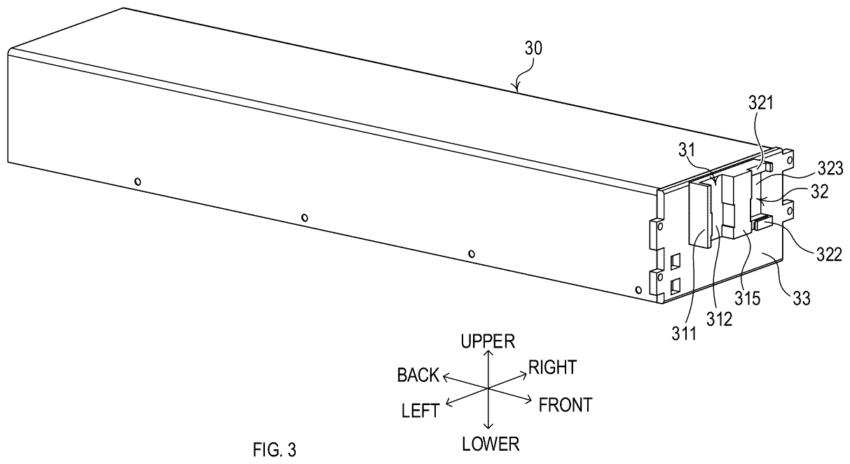

The following describes a configuration of a rack energy storage apparatus 100, with reference to the drawings. As shown in FIGS. 1 and 2, the rack energy storage apparatus 100 comprises a rack 10, energy storage modules 30, first busbars 40, an energy management system (hereinafter, EMS) 20, and a fuse 80. As shown in FIG. 3, each of the energy storage modules 30 is formed in a rectangular prismatic shape. The energy storage modules 30 are stored in the rack 10 in a stacked manner.

The energy storage modules 30 include a first energy storage module group 310 and a second energy storage module group 320. Each of the first and second energy storage module groups 310, 320 includes two or more energy storage modules 30 that are stacked on top of each other. In the present embodiment, each of the first and second energy storage module groups 310, 320 includes ten energy storage modules 30. In another embodiment, each of the first and second energy storage module groups 310, 320 may include less than ten energy storage modules 30, or may include eleven or more energy storage modules 30.

The second energy storage module group 320 is aligned with the first energy storage module group 310 in a direction perpendicular to a stacking direction of the energy storage modules 30. That is, the energy storage modules 30 are arranged in two rows within the rack 10. Hereinafter, the stacking direction is referred to as upper and lower directions. In addition, a direction where the first and second energy storage module groups 310, 320 are arranged side by side is referred to as right and left directions. Furthermore, a direction perpendicular to the upper and lower directions as well as the right and left directions is referred to as front and back directions.

The rack 10 comprises a door 11 and a housing 12. The housing 12 is formed in a rectangular prismatic shape and is open at its front. The door 11 is attached to the housing 12 in such a manner that an opening of the housing 12 can be opened and closed. The first and second energy storage module groups 310, 320 are stored in the housing 12 such that a longitudinal direction of the energy storage module 30 coincides with front and back directions of the housing 12. In another embodiment, the energy storage modules 30 may be stored in the rack 10 to be arranged in a single row or in three or more rows.

The EMS 20 is stored in the housing 12 and arranged above the first and second energy storage module groups 310, 320. The EMS 20 comprises a first port 53 and a second port 54 on a front surface of the EMS 20. The first port 53 is electrically coupled to a negative electrode terminal of the EMS 20, and the second port 54 is electrically coupled to a positive electrode terminal of the EMS 20. The EMS 20 receives electric power from the energy storage modules 30 to operate, and the EMS 20 manages charging and discharge of each of the energy storage modules 30.

As shown in FIGS. 1 to 4, each of the energy storage modules 30 has a front surface 33, and comprises a first terminal connector 31, a second terminal connector 32, and an intermediate part 315 on the front surface 33. The first terminal connector 31 and the second terminal connector 32 are aligned in right and left directions, and the intermediate part 315 is interposed therebetween. The first terminal connector 31 is arranged on a left side of the intermediate part 315, and the second terminal connector 32 is arranged on a right side of the intermediate part 315. The corresponding first terminal connector 31 is electrically coupled to a negative electrode of each of the energy storage modules 30, and the second terminal connector 32 is electrically coupled to a positive electrode of each of the energy storage modules 30.

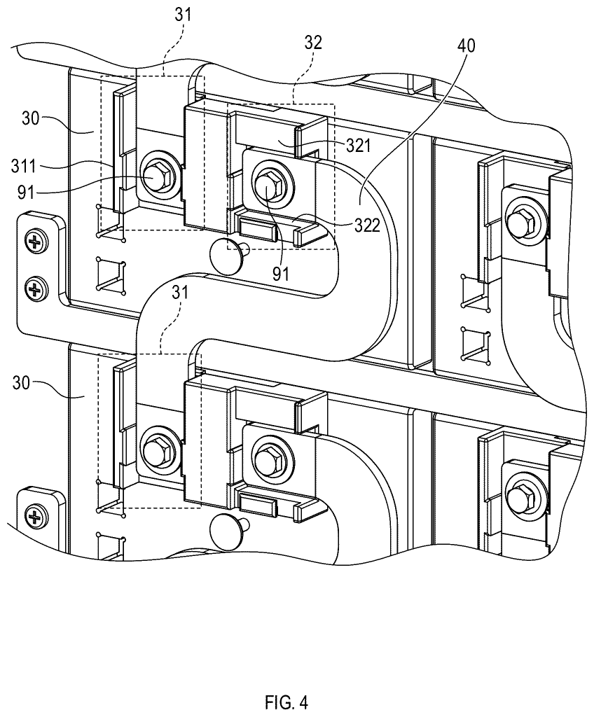

The first terminal connector 31 comprises a first placement surface 312, a side wall 311, and a first cover 331. The second terminal connector 32 comprises a second placement surface 323, a first guide wall 321, a second guide wall 322, and a second cover 332. The first placement surface 312 and the second placement surface 323 are made of conductive members, such as metal. FIGS. 1 and 2 each show a state with the first and second covers 331, 332 attached. FIGS. 3 and 4 each show a state with the first and second covers 331, 332 detached.

The first terminal connector 31 extends in the upper and lower directions as well as the right and left directions, and its upper end and lower end are open. The first placement surface 312 extends in the upper and lower directions as well as the right and left directions, and is shaped in a rectangle whose longitudinal direction is the upper and lower directions. The side wall 311 is a plate-shaped member. The side wall 311 is arranged at a left end of the first placement surface 312 and protrudes frontward from the front surface 33. The first cover 331 is a plate-shaped member having the same shape as the first placement surface 312.

The intermediate part 315 has a rectangular prismatic shape. The intermediate part 315 is arranged at a right end of the first placement surface 312. A first end portion 41 of each of the first busbars 40 is placed on the first placement surface 312. The first end portion 41 of each of the first busbars 40 will be described below. The first cover 331 is fitted between the side wall 311 and the intermediate part 315, and the first cover 331 covers the first end portion 41 placed on the first placement surface 312.

The second terminal connector 32 extends in the upper and lower directions as well as the right and left directions, and the second terminal connector 32 is open at its end in the right and left directions. Specifically, a right end, of the two ends of the second terminal connector 32 in the right and left directions, is further away from the first terminal connector 31. The right end is open. The second placement surface 323 extends in the upper and lower directions as well as the right and left directions. The second placement surface 323 has a rectangle shape whose longitudinal direction is the right and left directions.

The first guide wall 321 is a plate-shaped member. The first guide wall 321 is arranged at an upper end of the second placement surface 323. A left end of the first guide wall 321 is in contact with the intermediate part 315. The second guide wall 322 is a plate-shaped member. The second guide wall 322 is arranged at a lower end of the second placement surface 323. A left end of the second guide wall 322 is in contact with the intermediate part 315.

The distance between the first guide wall 321 and the second guide wall 322 is the same as a width W of a second end portion 42 of each of the first busbars 40. The second end portion 42 of each first busbar will be described below. When mounting the first busbar 40, the second end portion 42 is moved onto the second placement surface 323 from a left side of the second placement surface 323 while coming into contact with the first and second guide walls 321, 322. That is, the second end portion 42 is guided onto the second placement surface 323 by the first and second guide walls 321, 322. The second end portion 42 is placed on the second placement surface 323 in a position where a left end of the second end portion 42 is in contact with the intermediate part 315. The second cover 332 is fitted between the first guide wall 321 and the second guide wall 322, and the second cover 332 covers the second end portion 42 placed on the second placement surface 323.

In another embodiment, the distance between the first guide wall 321 and the second guide wall 322 may be a width with a margin added to the width W. Addition of the margin to the distance as described above can absorb a positioning tolerance (assembly tolerance) of each of the first busbars 40 in the upper and lower directions.

Each of the first busbars 40 is a plate-shaped member and has a first surface 451 and a second surface 452 opposite to the first surface 451. Each of the first busbars 40 is a conductive member made of metal, for example, copper. Since the first busbars 40 are exposed, the first and second surfaces 451, 452 are coated with resin to inhibit corrosion.

Each of the first busbars 40 includes an S-shaped part 43 formed in an S-shape (or crank-like shape, or N-shape) and an extension part 44 extending from an end of the S-shaped part 43. The S-shaped part 43 includes a first part 431, a second part 432, and a third part 433. Each of the first part 431 and the second part 432 has a rectangular prismatic shape with some of their corners rounded, and extends in the upper and lower directions. The third part 433 has a rectangular prismatic shape and connects the first part 431 and the second part 432 with each other. The third part 433 extends in the right and left directions. The extension part 44 has a rectangular prismatic shape with some of its corners rounded, and extends in the right and left directions from an end of the second part 432. That is, the extension part 44 is perpendicular to the first part 431.

The first part 431 has the first end portion 41. The first end portion 41 is coupled to the first terminal connector 31. The extension part 44 has the second end portion 42. The second end portion 42 is perpendicular to the first end portion 41 and is coupled to the second terminal connector 32. The first end portion 41 includes a first hole 411 formed therein, and the second end portion 42 includes a second hole 412 formed therein. The first hole 411 is formed in a circular shape, and the second hole 412 is formed in an elliptical shape elongating in the upper and lower directions. A bolt 91 is inserted through the first hole 411. A bolt 91 is inserted through the second hole 412. The second hole 412 has the elliptical shape, and thus a positioning tolerance of each of the first busbars 40 in the upper and lower directions can be absorbed.

In another embodiment, if the distance between the first guide wall 321 and the second guide wall 322 is a width with a margin added to the width W, the margin of the distance and the elliptical shape of the second hole 41 as described above can have a synergistic effect, thereby to further absorb positioning tolerance of each of the first busbars 40 in the upper and lower directions.

The first end portion 41 is fastened to the first placement surface 312 with the bolt 91 via a first washer 92 and a second washer 93. This brings the first end portion 41 into conduction with the negative electrode of the energy storage module 30. The bolts 91, the first washer 92, and the second washer 93 are conductive members made of metal or the like. The second washer 93 has a larger diameter than that of the first washer 92. The second end portion 42 is fastened to the second placement surface 323 with the bolt 91 via a first washer 92 and a second washer 93. This brings the second end portion 42 into conduction with the positive electrode of the energy storage module 30.

Each of the first busbars 40 couples one of the energy storage modules 30 in series with another of the energy storage modules 30. Each of the first busbars 40 is arranged such that its first surface 451 is at the front, and the lower-positioned one of the energy storage modules 30 is coupled in series with the upper-positioned one of the energy storage modules 30 in the first energy storage module group 310. Specifically, one of the first busbars 40 connects the second terminal connector 32 of the upper-positioned one of the energy storage modules 30 to the first terminal connector 31 of the lower-positioned one of the energy storage modules 30 in the first energy storage module group 310.

On the other hand, each of the first busbars 40 is arranged such that its second surface 452 is at the front, and the lower-positioned one of the energy storage modules 30 is coupled in series with the upper-positioned one of the energy storage modules 30 in the second energy storage module group 320. Specifically, one of the first busbars 40 connects the second terminal connector 32 of the lower-positioned one of the energy storage modules 30 to the first terminal connector 31 of the upper-positioned one of the energy storage modules 30 in the second energy storage module group 320.

The second terminal connector 32 of a first lowermost module 30 is coupled to the first terminal connector 31 of a second lowermost module 30 via the fuse 80. Accordingly, the first lowermost module 30 is coupled in series with the second lowermost module 30. The first lowermost module 30 is a lowermost one of the energy storage modules 30 located in a lowermost position in the first energy storage module group 310. The second lowermost module 30 is a lowermost one of the energy storage modules 30 located in a lowermost position in the second energy storage module group 320. The fuse 80 is blown when a large current exceeding a preset threshold flows.

In addition, the first terminal connector 31 of a first uppermost module 30 is coupled to the first port 53 of the EMS 20 via a first upper busbar 51. The second terminal connector 32 of a second uppermost module 30 is coupled to the second port 54 of the EMS 20 via a second upper busbar 52. The first uppermost module 30 is an uppermost one of the energy storage modules 30 located in an uppermost position in the first energy storage module group 310. The second uppermost module 30 is an uppermost one of the energy storage modules 30 located in an uppermost position in the second energy storage module group 320. The first and second upper busbars 51, 52 are conductive members made of metal, for example, copper. Outer surfaces of the first and second upper busbars 51, 52 are coated with resin.

### 2. Internal Structure of Energy Storage Module

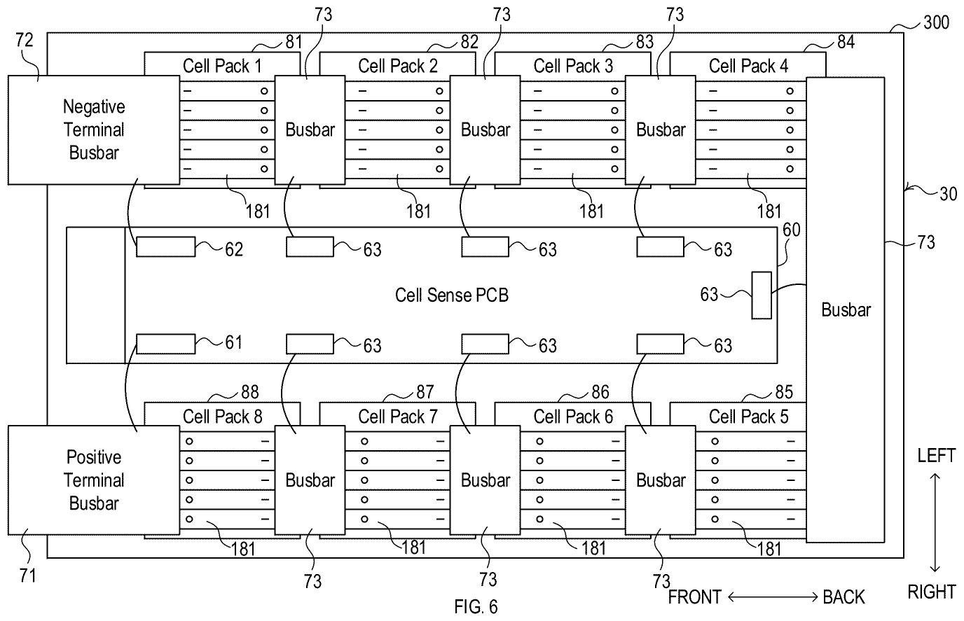

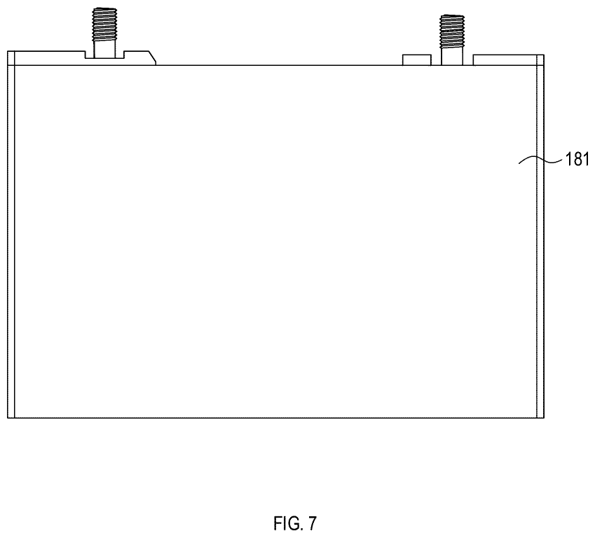

Referring to FIGS. 6 and 7, an internal structure of each of the energy storage modules 30 is described. Each of the energy storage modules 30 comprises a module case 300, eight cell packs 81 to 88, a positive electrode terminal busbar 71, a negative electrode terminal busbar 72, second busbars 73, and a cell sensor printed circuit board (hereinafter, PCB) 60. The number of the cell packs included in the energy storage module 30 is not limited to eight, and it is sufficiently that two or more cell packs are included.

The module case 300 stores the eight cell packs 81 to 88, the second busbars 73, and the cell sensor PCB 60, a portion of the positive electrode terminal busbar 71, and a portion of the negative electrode terminal busbar 72. An end part of the positive electrode terminal busbar 71 and an end part of the negative electrode terminal busbar 72 protrude beyond the module case 300. The first end portion 41 of the first busbar 40 is electrically coupled to the positive electrode terminal busbar 71 via the first placement surface 312. The second end portion 42 of the first busbar 40 is electrically coupled to the negative electrode terminal busbar 72 via the second placement surface 323.

Each of the cell packs 81 to 88 includes two or more energy storage cells 181 that are stacked. The energy storage cells 181 are hybrid supercapacitors each having a hybrid structure of a lithium-ion battery and an electric double layer capacitor. The hybrid supercapacitor is also referred to as a lithium-ion capacitor. The hybrid supercapacitor is achieved by a positive electrode made from the same active carbon as that of the electric double layer capacitors, by a negative electrode made from the same carbon as that of the lithium-ion battery, and by a pre-doping technique. The energy storage cells 181 can each achieve high-energy density and high-power density, as well as be charged and discharged with a large current while being smaller in size. Furthermore, the energy storage cells 181 each have excellent high-temperature durability and can be each used in a wide temperature range.

The cell packs 81 to 88 are aligned in order from the cell pack 81 and surround the cell sensor PCB 60 having a rectangular shape. The second busbars 73 are conductive members made of metal. Each of the second busbars 73 couples two or more energy storage cells 181 inside a cell pack in parallel, and also couples adjacent cell packs in series. For example, one of the second busbars 73 is coupled to positive electrodes of all the energy storage cells 181 inside the cell packs 81, and is also coupled to negative electrodes of all the energy storage cells 181 inside the cell packs 82.

That is, each of the second busbars 73 is coupled to the positive electrodes of all the energy storage cells 181 contained in one of adjacent cell packs, and is coupled to the negative electrodes of all the energy storage cells 181 contained in the other of the adjacent cell packs. The negative electrodes of all the energy storage cells 181 contained in the cell pack 81 are coupled to the negative electrode terminal busbar 72. The cell pack 81 is situated in the outermost position. The positive electrodes of all the energy storage cells 181 contained in the cell pack 88 are coupled to the positive electrode terminal busbar 71. The cell pack 88 is opposite to the outermost position.

The cell packs 81 to 84 are arranged leftward of the cell sensor PCB 60, and the cell packs 85 to 88 are arranged rightward of the cell sensor PCB 60. The cell packs 85 to 88 are arranged in a manner 180° reversed with respect to the cell packs 81 to 84 to face the cell packs 81 to 84. Specifically, the cell pack 88 is arranged in a manner 180° reversed with respect to the cell pack 81 so as to face the cell pack 81. The negative electrode of the cell pack 88 faces the positive electrode of the cell pack 81, and the positive electrode of cell pack 88 faces the negative electrode of the cell pack 81.

The cell sensor PCB 60 comprises a board positive electrode terminal 61, a board negative electrode terminal 62, and detection terminals 63, and detects a voltage value and a temperature of each of the cell packs 81 to 88. The board positive electrode terminal 61 is electrically coupled to the positive electrode terminal busbar 71. The board negative electrode terminal 62 is electrically coupled to the negative electrode terminal busbar 72. Each of the detection terminals 63 is coupled to a corresponding one of the second busbars 73. The cell sensor PCB 60 detects the voltage value and temperature of each of the cell packs 81 to 88 via a corresponding one of the detection terminals 63. The cell sensor PCB 60 transmits, to the EMS 20, the detected voltage value and temperature of each of the cell packs 81 to 88. The EMS 20 can manage the voltage and the temperature for each cell pack of the energy storage modules 30.

### 3. Effects

The present embodiment, as described in detail above, the following effects are achieved.
(1) An orientation of the openings of the first terminal connector 31 is perpendicular to an orientation of the opening of the second terminal connector 32. Accordingly, it is possible to avoid coupling the first busbar 40 to two first terminal connectors 31 of the same polarity and causing a short circuit. In addition, it is possible to avoid coupling the first busbar 40 to two second terminal connectors 32 of the same polarity and causing a short circuit. Accordingly, it is possible to inhibit the incorrect connection of each of the first busbars 40 with a relatively simple configuration.
(2) Each of the first busbars 40 has the S-shaped part 43, and thus the distance between the first terminal connector 31 of the lower-positioned one of the energy storage modules 30 and the second terminal connector 32 of the upper-positioned one of the energy storage modules 30 can be reduced. This can thus inhibit the rack energy storage apparatus 100 from being larger in size.
(3) The first and second terminal connectors 31, 32 are aligned in the right and left directions of the front surface 33, and thus it is possible to inhibit a height of the energy storage module 30 from increasing in the upper and lower directions. This further inhibits the rack energy storage apparatus 100 from being larger in size.
(4) The second terminal connector 32 has the first and second guide walls 321, 322, and this allows the second end portions 42 of the first busbars 40 to be brought into contact with the respective first and second guide walls 321, 322 and moved onto the respective second placement surfaces 323. Accordingly, each of the first busbars 40 can be easily coupled to the corresponding first terminal connector 31 and to the corresponding second terminal connector 32.
(5) The first energy storage module group 310 and the second energy storage module group 320 are aligned in two rows, and thus the first busbars 40 can be used in common for the first energy storage module group 310 and the second energy storage module group 320. At the first energy storage module group 310, each of the first busbars 40 is arranged such that the corresponding one of the first surfaces 451 faces the front. At the second energy storage module group 320, each of the first busbars 40 is arranged such that the corresponding one of the second surfaces 452 faces the front. Accordingly, the second energy storage module group 320 can be easily coupled in series with the first energy storage module group 310 using a single type of busbars, the first busbars 40.
(6) The cell packs 85 to 88 are arranged in a manner 180° reversed with respect to the cell packs 81 to 88 so as to face the cell packs 81 to 88, and thus the energy storage module 30 can be made smaller in size.
(7) The energy storage cells 181 are lithium-ion capacitors, and thus the energy density and power density can be increased. Accordingly, it is possible to charge and discharge the energy storage cells 181 with large currents while making the energy storage cells 181 smaller in size. Furthermore, the temperature range of the energy storage cells 181 in use can be expanded.
(8) The cell sensor PCB 60 inside each of the energy storage modules 30 detects the voltage value and temperature of an individual one of the cell packs 81 to 88. Accordingly, the EMS 20 can manage the voltage and temperature for each cell pack inside the energy storage modules 30, rather than each of the energy storage modules 30.

[EXPLANATION OF REFERENCE NUMERALS]

10 . . . rack, 30 . . . energy storage modules, 31 . . . first terminal connector,
32 . . . second terminal connector, 33 . . . front surface, 40 . . . first busbars, 41 . . . first end
portion, 42 . . . second end portion, 43 . . . S-shaped part, 44 . . . extension part, 60 . . . cell
sensor PCB, 73 . . . second busbar, 80 . . . fuse, 81 to 88 . . . cell packs, 100 . . . rack energy
storage apparatus, 181 . . . energy storage cells, 310 . . . first energy storage module
group, 320 . . . second energy storage module group, 321 . . . first guide wall,
322 . . . second guide wall.

1. A rack energy storage apparatus, comprising:
a rack;
energy storage modules configured to be stored in the rack in a stacked manner; and
first busbars configured to couple the energy storage modules in series with each other, wherein
each energy storage module includes:
energy storage cells;
a first terminal connector arranged on a specific face of the energy storage module, the first terminal connector extending in a stacking direction of the energy storage modules and being open at ends of the first terminal connector in the stacking direction; and
a second terminal connector arranged on the specific face, the second terminal connector extending in a perpendicular direction and being open at an end of the second terminal connector in the perpendicular direction, the perpendicular direction being perpendicular to the stacking direction; and
each first busbar includes:
a first end portion extending in the stacking direction and being configured to be coupled to the first terminal connector; and
a second end portion extending in the perpendicular direction and being configured to be coupled to the second terminal connector.

2. The rack energy storage apparatus according to claim 1, wherein
the first busbar is a plate-shaped member and includes:
an S-shaped part having an S-shape and including the first end portion; and
an extension part extending from an end of the S-shaped part opposite to the first end portion so as to be perpendicular to the first end portion, the extension part including the second end portion.

3. The rack energy storage apparatus according to claim 1, wherein
the first terminal connector and the second terminal connector are aligned in the perpendicular direction.

4. The rack energy storage apparatus according to claim 1, wherein
the second terminal connector includes a guide wall extending in the perpendicular direction.

5. The rack energy storage apparatus according to claim 1, further comprising:
a management portion configured to manage the energy storage modules; and
a fuse, wherein
the energy storage modules include a first energy storage module group and a second energy storage module group,
the first and second energy storage module groups each include two or more energy storage modules stacked, of the energy storage modules, in the stacking direction, the second energy storage module group being aligned with the first energy storage module group in the perpendicular direction,
uppermost energy storage modules of the first and second energy storage module groups are coupled to the management portion, and
a lowermost energy storage module of the first energy storage module group is coupled to a lowermost energy storage module of the second energy storage module group via the fuse.

6. The rack energy storage apparatus according to claim 1, wherein
each energy storage module includes:
cell packs arranged in series with each other; and
a second busbar coupling adjacent cell packs, of the cell packs, in series with each other,
the cell packs include two or more energy storage cells, of the energy storage cells, the two or more energy storage cells being aligned, and
the cell packs include:
a first cell pack, and
a second cell pack arranged in a manner 180° reversed with respect to the first cell pack so as to face the first cell pack.

7. The rack energy storage apparatus according to claim 6, wherein
the energy storage cells are lithium-ion capacitors.

8. An energy storage module to be accommodated in a rack, the energy storage module comprising:
a module case;
cell packs accommodated in an aligned manner in the module case, the cell packs including a first cell pack and a second cell pack, each of the cell packs including energy storage cells aligned, the second cell pack being arranged in a manner 180° reversed with respect to the first cell pack so as to face the first cell pack;
a busbar coupling the energy storage cells in parallel and coupling adjacent cell packs of the cell packs in series with each other; and
a circuit board configured to detect a temperature and a voltage of each of the cell packs.

9. The energy storage module according to claim 8, wherein
the energy storage cells are lithium-ion capacitors.
